(19) United States
(12) Patent Application Publication
(10) Pub. No.: US 2017/0288574 A1
(43) Pub. Date: Oct. 5, 2017

(54) NEUTRAL POINT REGULATOR HARDWARE FOR A MULTI-LEVEL DRIVE

(71) Applicant: Otis Elevator Company, Farmington, CT (US)

(72) Inventors: Ismail Agirman, Southington, CT (US); HanJong Kim, Avon, CT (US)

(21) Appl. No.: 15/507,642

(22) PCT Filed: Jul. 9, 2015
(86) PCT No.: PCT/US2015/039704

§ 371 Date: Feb. 28, 2017

Related U.S. Application Data
(60) Provisional application No. 62/043,088, filed on Aug. 28, 2014.

(51) Int. Cl. H02M 7/487; H02M 7/5387; H02M 1/32

(52) U.S. Cl. CPC H02M 7/487; H02M 1/32; H02M 7/53871; H02P 27/06

(57) ABSTRACT

The present disclosure relates generally to a neutral point balancing scheme for power converter systems. The balancing circuit includes a first side of a first electrical component operably coupled to a mid-point of the DC link capacitor bank, and a switching combination operably coupled to the second side of the first electrical component, a positive voltage, and a negative voltage rail, wherein the switching combination is configured to generate a pulse-width modulation signal at the second side of the first electrical component.

### CROSS REFERENCE TO RELATED APPLICATIONS

The present application is related to, and claims the priority benefit of, U.S. Provisional Patent Application Ser. No. 62/043,088 filed Aug. 8, 2014, the contents of which are hereby incorporated in their entirety into the present disclosure.

### TECHNICAL FIELD OF THE DISCLOSED EMBODIMENTS

The present disclosure is generally related to power converters and, more specifically, a neutral point regulator hardware for a multi-level drive.

### BACKGROUND OF THE DISCLOSED EMBODIMENTS

Three-phase motors are used in various industrial applications and devices. Elevator systems, for example, typically utilize three-phase AC voltage drives to power hoist motors that move the elevator cars. Because these hoist motors can consume large amounts of energy, energy efficient power control systems are desirable for use in such elevator systems.

In typical elevator systems, a building AC voltage source is supplied to a rectifier circuit where it is converted into DC voltage. Inverters are then used to convert the DC voltage back into AC voltage having desirable characteristics. While inverters are well suited for such conversions, the resultant AC voltages typically contain various harmonic frequencies due to the power stage switching operations of the inverters. These harmonic frequencies are undesirable and can negatively affect the related elevator systems when present. The potential impact of harmonic frequencies can be estimated by considering the total harmonic distortion (THD) of a system, where the THD is a measure of the distortion that is present in a signal as it passes through the system. In general, systems with less THD are more desirable.

The neutral-point-clamped (NPC) three-level inverter is suitable for use in elevator systems because the voltage stress on its switching power devices is half the voltage stress on the devices used in a conventional two-level inverter. However, one issue associated with the NPC three-level inverter is its neutral point potential variation. Under certain conditions, the DC-link neutral point potential can significantly fluctuate or continuously drift to unacceptable levels. As a result, the switching devices may fail due to overvoltage stress rendering the drive unreliable. There is therefore a need for a neutral point voltage balancing scheme to reduce the neutral point potential variation.

### SUMMARY OF THE DISCLOSED EMBODIMENTS

In one aspect, a multi-level converter system is provided. The multi-level converter system utilizes a neutral point clamp (NPC) topology further including a positive voltage rail, a negative voltage rail, and a balancing circuit operably coupled to the neutral point. The balancing circuit includes one side of an first electrical component operably coupled to the neutral point, and the other side of the first electrical component operably coupled to a switching combination, the positive voltage rail, and the negative voltage rail, wherein the switching combination is configured to generate a pulse-width modulation signal at the second side of the first electrical component.

In one embodiment, the switching combination includes a plurality of switches, wherein a first one of the switches is coupled to the second side of the first electrical component and the positive voltage rail, a second one of the switches serially connected to the first one of the switches, and the second one of the switches is coupled to the second side of the first electrical component and the negative voltage rail. In one embodiment, the first electrical component includes an inductor. In one embodiment, the balancing circuit further includes a sensor located adjacent to the first electrical component. In one embodiment, the sensor includes an inductor sensor.

In one aspect, a method for providing voltage balance control for a multi-level converter including a DC link capacitor bank further including at least one mid-point at a floating potential between a positive voltage rail and a negative voltage rail, and a balancing circuit operably coupled to the mid-point of the multi-level converter, wherein the balancing circuit comprises a plurality of switches operably coupled to a first electrical component, the method includes the step of determining a voltage difference signal, wherein the voltage difference signal includes the difference between a first voltage and a second voltage to create a voltage difference signal, wherein the first voltage includes the voltage between the positive voltage rail and the at least one mid-point and the second voltage comprises the voltage between the negative voltage rail and the at least one mid-point.

The method further includes the step of determining a current reference value by passing the voltage difference signal through a first regulator.

The method further includes the step of determining a neutral point error signal by determining the difference between the current reference value and a measured current value. In one embodiment, the measured current value comprises a current value measured at a location adjacent to the first electrical component.

The method further includes the step of actuating at least one of the switches based at least in part on the neutral point error signal. In one embodiment, the at least one switch is actuated based upon an output of the neutral point error signal from a second regulator.

Other embodiments are also disclosed.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic diagram of a NPC three-level inverter circuit topology;

FIG. 2 is a schematic diagram of a neutral point balancing circuit operable coupled to a NPC three-level circuit topology;

FIG. 3 is a schematic diagram of an embodiment of a neutral point balancing circuit operable coupled to a NPC three-level circuit topology; and

FIG. 4 is a schematic flow diagram of a control circuit used with the neutral point balancing circuit of FIG. 3.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

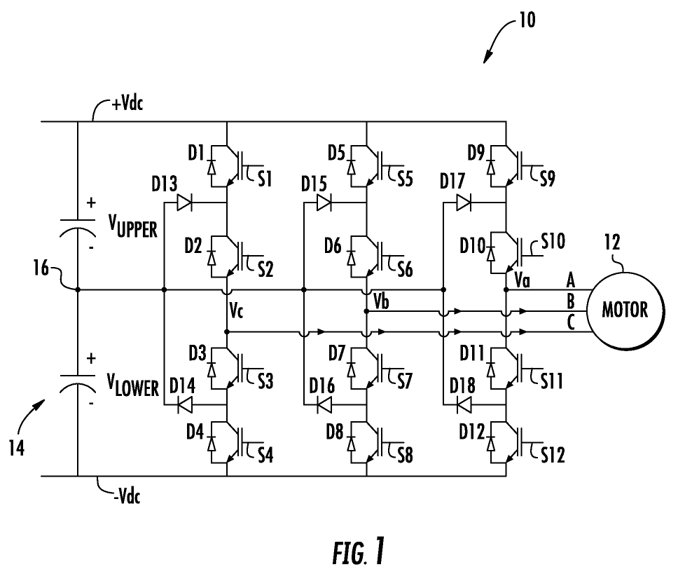

FIG. 1 illustrates a NPC three-level converter system, generally indicated at 10. The converter system 10 depicted in this embodiment utilizes a neutral point clamp (NPC) topology having three converter legs and a pair of clamping diodes D13, D14, D15, D16, D17, D18 across each respective converter leg. Switches S1-S4 provide a first three-level converter leg, switches S5-S8 provide a second three-level converter leg, and switches S9-S12 provide a third three-level converter leg. It will be appreciated that switches S1-S12 may include insulated-gate bipolar transistors (IGBTs), metal-oxide-semiconductor field-effect transistors (MOSFETs), integrated gate-commutated thyristors (IGCTs), or other similar types of high voltage switches, to name a few of non-limiting examples. When operating as an inverter, the three-level converter legs respectively provide AC power to AC nodes Va, Vb and Vc corresponding to motor winding phases A, B and C of motor 12. When operating as rectifier, each three-level converter leg converts an AC voltage applied at one of AC nodes Va, Vb and Vc, to a DC voltage across positive DC node +VDC and negative DC node −VDC.

The converter system 10 further includes a capacitor bank 14 with a neutral point 16. For optimal operation, the same magnitude of voltage should be present on each side of neutral point 16 of the capacitor bank 14 (that is, balanced). For a three-level converter, voltage balancing is commonly referred to as neutral point balancing.

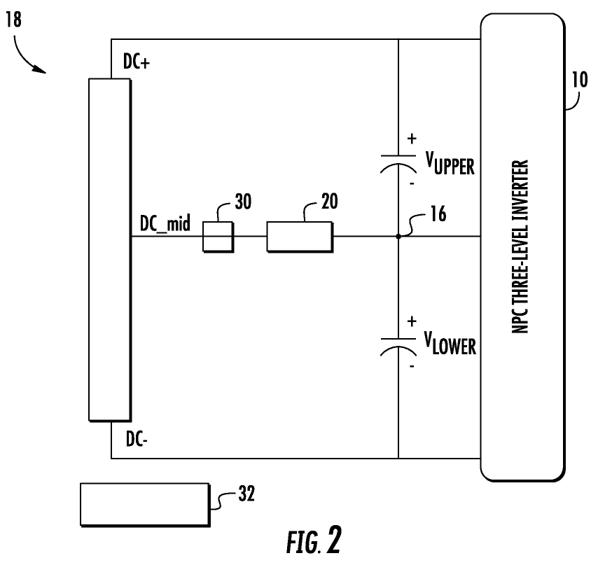

As shown in FIG. 2, the system 10 further includes a balancing circuit 18 operably coupled to the neutral point 16. The balancing circuit 18 includes one side of an first electrical component 20 operably coupled to the neutral point 16, and the other side of the first electrical component 20 operably coupled to a switching combination operably coupled to the second side of the first electrical component 20, a positive voltage, and a negative voltage rail, wherein the switching combination is configured to generate a pulse-width modulation signal at the second side of the first electrical component 20.

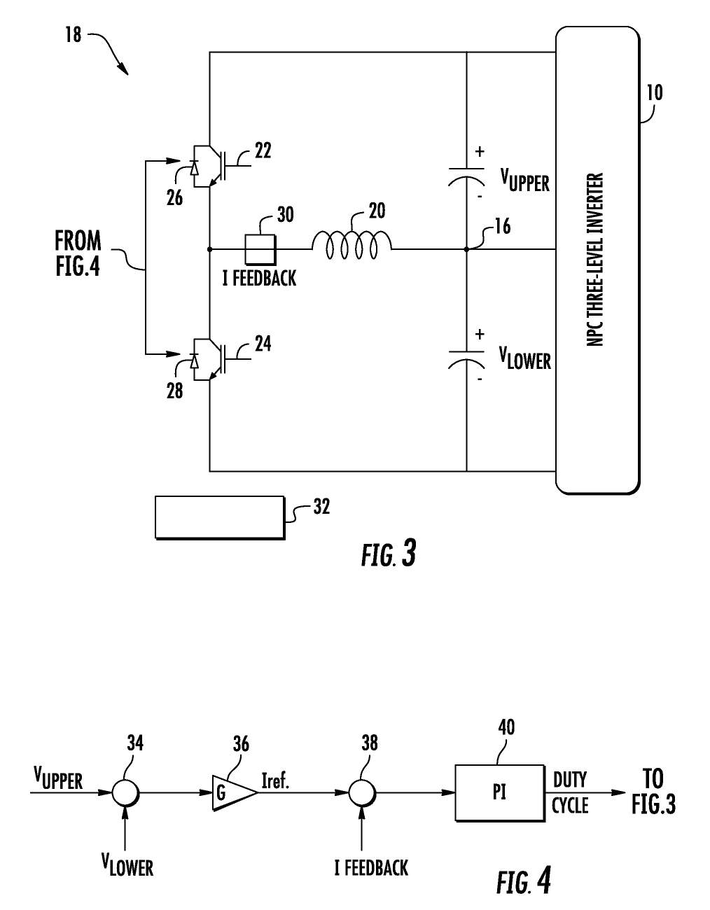

In one embodiment, as shown in FIG. 3, the switching combination includes a pair of switches 22 and 24. In one embodiment, the first electrical component 20 includes an inductor. It will be appreciated that switches 22 and 24 may include insulated-gate bipolar transistors (IGBTs), metal-oxide-semiconductor field-effect transistors (MOSFETs), integrated gate-commutated thyristors (IGCTs), or other similar types of high voltage switches, to name a few of non-limiting examples. In the example shown, switches 22 and 24 are each associated with a diode 26 and 28 respectively. Each diode 26 and 28 is connected with its cathode coupled to the collector and its anode coupled to the emitter of switch 22 and 24, respectively. The other end of the inductor 20 is coupled to the anode of diode 26 and the cathode of diode 28. In one embodiment, the balancing circuit 18 further includes a sensor 30 located adjacent to the first electrical component 20. In one embodiment, the sensor 30 includes an inductor sensor. The sensor 30 is configured to measure the current at the neural point 16. It will be appreciated that the balancing circuit 18 may be used on any inverter topology that includes a neutral point 16.

FIG. 4 is a diagram of a control diagram in accordance with one embodiment of regulating the duty cycle of the switches 22 and 24 and the neutral point 16 of the system 10. Controller 32, shown in FIG. 2, is configured to obtain an error signal representative of the voltage imbalance at neutral point 16, and using a neutral point regulator 40 to provide a neutral point command for maintaining the voltage within a threshold.

The voltage imbalanced used by the neutral point regulator 38 may be obtained in one embodiment by obtaining the difference between the two voltages (Vᵤₚₚₑᵣ and V_{lower}) across the capacitors via a difference element 34. That signal is then passed through a regulator 36 to determine a current reference value (I_{ref}). The signal representative of the neutral point error is the result of passing the current reference value (I_{ref}) and the measured current from the sensor 30 (I_{feedback}) through difference element 38. The neutral point error is passed through the neutral point regulator 40. In one embodiment neutral point regulator 40 comprises a proportional integral (PI) regulator (to drive the neutral point error towards zero). The output produces a duty cycle command to alternate between turning on switch 22 and turning off switch 24, and vice versa. For example, when Vᵤₚₚₑᵣ is greater than V_{lower}, the neutral point regulator 40 sends a signal to turn on switch 24, and turn off switch 22. When V_{lower} is greater than Vᵤₚₚₑᵣ, the neutral point regulator 40 sends a signal to turn on switch 22, and turn off switch 24. When one of the switches 22 or 24 is on, but the other is not; then, the neutral point is adjusted and balancing can occur.

It will be appreciated that the balancing circuit 18 and the neutral point regulator 40 provides for an independent means of balancing the voltage at neutral point 16 by producing a duty cycle command to alternate between turning on switch 22 and turning off switch 24, and vice versa.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A balancing circuit for a multi-level converter including a DC link capacitor bank, the balancing circuit comprising:
a first electrical component, wherein a first side of the first component is operably coupled to a mid-point of the DC link capacitor bank, the mid-point including a floating potential between a positive voltage rail and a negative voltage rail; and
a switching combination operably coupled to the second side of the first electrical component, the positive voltage, and the negative voltage rail, wherein the switching combination is configured to generate a pulse-width modulation signal at the second side of the first electrical component.

2. The balancing circuit of claim 1, wherein the switching combination comprises:
a plurality of switches, wherein a first one of the switches is coupled to the second side of the first electrical component and the positive voltage rail, a second one of the switches serially connected to the first one of the switches, and the second one of the switches is coupled to the second side of the first electrical component and the negative voltage rail.

3. The balancing circuit of claim 1, further comprising a controller, wherein the controller is configured to provide control signals to the switching combination to selectively actuate the switches.

4. The balancing circuit of claim 1, further comprising a sensor located adjacent to the first electrical component.

5. The balancing circuit of claim 1, wherein the first electrical component comprises an inductor.

6. The balancing circuit of claim 4, wherein the sensor is located adjacent to the second side of the first electrical component.

7. The balancing circuit of claim 2, further comprising a plurality of diodes, wherein a first one of the diodes is coupled in parallel to the first one of the switches, and a second one of the diodes is coupled in parallel to the second one of the switches.

8. A power generation system comprising:
a multi-level converter, wherein the multi-level converter comprises a DC link capacitor bank; and
a balancing circuit operably coupled to the multi-level converter, wherein the balancing circuit comprises:
a first electrical component, wherein a first side of the first component is operably coupled to a mid-point of the DC link capacitor bank, the mid-point including a floating potential between a positive voltage rail and a negative voltage rail; and
a switching combination operably coupled to the second side of the first electrical component, the positive voltage, and the negative voltage rail, wherein the switching combination is configured to generate a pulse-width modulation signal at the second side of the first electrical component.

9. The power generation system of claim 8, wherein the switching combination comprises:
a plurality of switches, wherein a first one of the switches is coupled to the second side of the first electrical component and the positive voltage rail, a second one of the switches is serially connected to the first one of the switches, and the second one of the switches is coupled to the second side of the first electrical component and the negative voltage rail.

10. The power generation system of claim 8, further comprising a controller, wherein the controller is configured to provide control signals to the switching combination to selectively actuate the switches.

11. The power generation system of claim 8, further comprising a sensor located adjacent to the first electrical component.

12. The power generation system of claim 8, wherein the first electrical component comprises an inductor.

13. The power generation system of claim 11, wherein the sensor is located adjacent to the second side of the first electrical component.

14. The power generation system of claim 9, further comprising a plurality of diodes, wherein a first one of the diodes is coupled in parallel to the first one of the switches, and a second one of the diodes is coupled in parallel to the second one of the switches.

15. A method for providing voltage balance control for a multi-level converter including a DC link capacitor bank comprising at least one mid-point at a floating potential between a positive voltage rail and a negative voltage rail, and a balancing circuit operably coupled to the mid-point of the multi-level converter, wherein the balancing circuit comprises a plurality of switches operably coupled to a first electrical component, the method comprising the steps:
determining a voltage difference signal, wherein the voltage difference signal comprises the difference between a first voltage and a second voltage to create a voltage difference signal, wherein the first voltage comprises the voltage between the positive voltage rail and the at least one mid-point and the second voltage comprises the voltage between the negative voltage rail and the at least one mid-point;
determining a current reference value by passing the voltage difference signal through a first regulator;
determining a neutral point error signal by determining the difference between the current reference value and a measured current value; and
actuating at least one of the switches based at least in part on the neutral point error signal.

16. The method of claim 15, wherein the at least one switch is actuated based upon an output of the neutral point error signal from a second regulator.

17. The method if claim 15, wherein the measured current value comprises a current value measured at a location adjacent to the first electrical component.
